(19) United States
(12) Patent Application Publication
(10) Pub. No.: US 2018/0205790 A1
(43) Pub. Date: Jul. 19, 2018

(54) DISTRIBUTED DATA STRUCTURE IN A SOFTWARE DEFINED NETWORKING ENVIRONMENT

(71) Applicant: Hewlett Packard Enterprise Development LP, Houston, TX (US)

(72) Inventors: Anu Mercian, Palo Alto, CA (US); Raphael Amorim Dantas Leite, Sunnyvale, CA (US); Mario Antonio Sanchez, Palo Alto, CA (US); Joon-Myung Kang, Palo Alto, CA (US); Sujata Banerjee, Palo Alto, CA (US)

(21) Appl. No.: 15/406,417

(22) Filed: Jan. 13, 2017

(51) Int. Cl. H04L 29/08; H04L 12/44

(52) U.S. Cl. CPC H04L 67/1097; H04L 67/1095; H04L 12/44

(57) ABSTRACT

Distributed data structures in a software defined networking (SDN) environment is disclosed. One example is a system including at least one processor and a memory storing instructions executable by the at least one processor to access a tree data structure located at a central node in the SDN environment, retrieve, at a local node of the network, a sub-tree of the data structure, the sub-tree determined based on a management policy associated with the local node or the central node, and cache sub-trees of the data structure at respective local nodes to generate a distributed data structure in the environment.

### BACKGROUND

A software defined networking environment may deploy a large number of devices of varying types. Network attributes may be associated with the devices, and relationships between the devices and their attributes may be mapped and stored in data structures.

### BRIEF DESCRIPTION OF THE DRAWINGS

FIG. 1 is a functional block diagram illustrating one example of a system for a distributed data structure in an SDN environment.

FIG. 2 is a functional block diagram illustrating another example of a system for a distributed data structure in an SDN environment.

FIG. 3 is a flow diagram illustrating one example of a method for a distributed data structure in an SDN environment.

FIG. 4 is another flow diagram illustrating one example of a method for a distributed data structure in an SDN environment.

FIG. 5 is a block diagram illustrating one example of a computer readable medium for a distributed data structure in an SDN environment.

### DETAILED DESCRIPTION

Enterprise policy management may be a sophisticated process requiring processing, transmission, and storage of large amounts of information from a diverse number of sources and applications. Generally, enterprises maintain teams of experts to ensure accuracy of such information, and to maintain appropriate configurations of different devices in the organization. Such business practices incur high operational costs and generate complex operational protocols.

Software Defined Networking (SDN) enables the management of networks via a centralized controller. As network deployments widen to accommodate a larger number of devices of varying types, such as switches, routers, hosts, virtual machines, and so forth, there may be an exponential increase in the number of network attributes that may be associated with each device. A general Label Management System (LMS) may be utilized to maintain a common repository of attributes associated with the different network devices. Additionally, and/or alternatively, a Mapping Service may be utilized to provide context to the labels and label groups for both discovery and information retrieval of large quantities of data.

In some instances, enterprise policy management may be simplified by providing a tree-based label structure to associate device attributes. Such attributes may be made accessible to a central node (e.g., the centralized controller), for example, the controller in charge of the enterprise policy management. Generally, the controller may retrieve such data from different databases when there is a need to create or access a policy. LMS may be utilized in conjunction with SDN to provide a centralized location for availability and management of all devices in the network. In this context, the LMS data may be accessed using remote calls (e.g., URL call via network) by the controller.

However, based on the location of the database, there may be high delay in accessing the data and leading to a decline in the overall performance. Furthermore, as the network grows, there may be the possibility for the associated databases to grow exponentially. Accordingly, there is a need for an intelligent data distribution and storage system that scales with the increase in data, synchronizes content across data structures, reduces latency, and improves database management.

Sharding, as used herein, is a technique to retrieve and store a portion of data stored in a database. As described herein, a policy-based sharding technique may be utilized to intelligently shard the label tree in order to support scaling, synchronize content discovery and improve database management. Sharding may be utilized to partition portions of a tree data structure stored in a database at various locations. This enables faster data retrieval in cases where the database is located in remote locations. By sharding, data relevant to a local node in the SDN environment may be cached at the requested node for easy access. While many databases perform sharding, these existing techniques are not suitable to solve the problem described herein. An algorithm for sharding policy-based management databases is described herein, that incorporates specific challenges of a network of growing management services and policies, and tailors sharding to use cases.

As described herein, a Distributed Mapping Service (DMS) as a sharding technique provides intelligent database management of an exponentially growing label management system. Some of the reasons for the growth of a policy label management system may include use of multiple controllers in a single-domain organization for reasons of geographical distribution, synchronization across departments, or maintenance of a hierarchical structure for proper access control. Also, for example, label names may be aggregated into longer labels to maintain uniqueness, and to reduce duplication of label names among departments in an organization. As another example, a dynamic increase in the number of devices in a network due to BYOD (bring your own device) policies or wireless support to mobile devices in the domain, may lead to a substantial increase in the number and type of labels. As described herein, label names may be generated and destroyed based on the dynamicity of the devices on the network.

A further cause for a growth in the policy LMS may be a multi-domain architecture where multiple organizations are inter-dependent for services. In this case, each organization may generate a specific label tree tailored to the organization. Accordingly, a middle-layer (an intermediate tree) may be utilized to associate the required label trees between the organizations so as to share the relevant information. This process introduces an additional, intermediate layer of label trees, resulting in more latencies.

Another cause for a growth in the policy LMS may be security policies associated with sub-groups and various combinations of sub-groups. In such cases, new label sub-groups may be generated to place the rules, resulting in a growth of sub-trees.

These and other reasons for a growing LMS challenge the efficient utilization of databases for easy retrieval of information and availability of information at end-point groups in a network. For an efficient implementation of LMS, there is a need for database storage and retrieval mechanisms to be tied to the specific reasons for growth of a policy-based LMS.

As described in various examples herein, a distributed data structure in an SDN environment is disclosed. One example is a system including at least one processor and a memory storing instructions executable by the at least one processor to access a tree data structure located at a central node in the SDN environment, retrieve, at a local node of the network, a sub-tree of the data structure, the sub-tree determined based on a management policy associated with the local node or the central node, and cache sub-trees of the data structure at respective local nodes to generate a distributed data structure in the environment.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

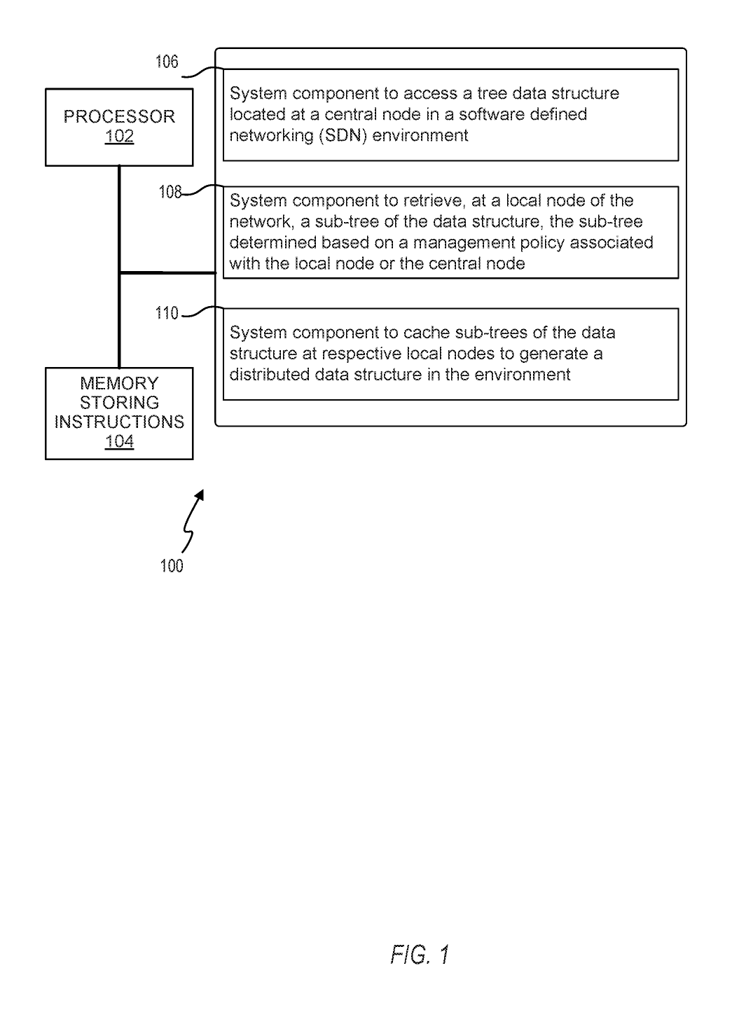

FIG. 1 is a functional block diagram illustrating one example of a system 100 for a distributed data structure in an SDN environment. System 100 is shown to include a processor 102, and a memory 104 storing instructions to enable a plurality of system components 106-110 to perform various functions of the system.

The term “system” may be used to refer to a single computing device or multiple computing devices that communicate with each other (e.g. via a network) and operate together to provide a unified service. In some examples, the components of system 100 may communicate with one another over a network. As described herein, the network may be any wired or wireless network, including a network of cloud computing resources, and may include any number of hubs, routers, switches, cell towers, and so forth. Such a network may be, for example, part of a cellular network, part of the internet, part of an intranet, and/or any other type of network.

Memory 104 may store instructions for a system component 106 to access a tree data structure located at a central node in a software defined networking (SDN) environment. In general, a tree-based management system may include a hierarchical tree where the sub-trees are dependent on a root, and an availability of relationships between nodes of one tree with another. The master tree, or the tree data structure located at the central node may be a non-sparse structure that is available in its entirety at a network controller. The tree data structure may be incrementally or exponentially growing. In some examples, the central node may be a centralized network controller that manages policies for the network. In some examples, there may be a plurality of central nodes performing such management functions.

For the purposes of describing the system, we may refer to a non-binding example of the LMS structure to understand the sharding algorithm. Similar techniques may apply to other data structures as well.

Some useful attributes of a data structure, such as the LMS, are a hierarchical tree, relational mapping (mapping with different tree nodes), a non-sparse master tree data structure with all nodes defined and included. A sharded sub-tree, as described herein, will generally be a sparse subset of the master tree data structure, sampling only relevant nodes, where the relevance is determined by a management policy.

An end point group (EPG) in a network may be broadly defined as a collection of points with a pre-defined property. For example, and EPG may be a computing device represented by an IP address or a MAC address. In some examples, an EPG may be a plurality of devices, for example, devices in one organization, or devices in a campus network, or sub-devices of a device or devices. Generally, such EPGs are connected to each other in a software defined networking environment. If the letter “A” denotes an EPG, then a function G(A) may be associated with A, where the function describes dependencies of A on other EPGs, such as X, Y, Z. Such dependencies may be, for example, associations in a LMS or the dependencies may be derived from management policies. Accordingly, we may denote G(A)={X, Y, Z}. In some examples, based on a location of EPG A in a label tree, A may have dependencies to a parent and child(ren). Accordingly, we may denote Parent (A)={A1} and Children (A)={B1, B2, . . . , Bn}, where n is a finite number. If the label tree is not binary, then it is possible for n to be greater than 2.

The length of A, and a length of each of its functions (such as G(A)) may be determined. In general, the tree data structure at the central node has longer length than any of its proper sub-trees. A size of an EPG A may be determined as a number of dependents based on policies.

In some examples, a constraints function may be generated, where the constraints function is based on policies dependent on A and its associated EPGs, and may be related to service labels in the label-tree. For example, Constraints (A)={M, N, L}, where M, N, L are service labels. In some examples, EPGs may have length as a constraint. In some examples, the constraint function for an EPG may include a number of dependents on other EPGs. Generally, policy dependents may include EPGs, actions and classifiers. Actions may be generally limited to “allow”, “block”, “redirect”, “conditional” and so forth, and may not include limitations. There may be a plurality of constraints based on the classifiers and such constraints may represent the label management system as a relation associated to a label.

Memory 104 may store instructions for a system component 108 to retrieve, at a local node of the network, a sub-tree of the data structure, the sub-tree determined based on a management policy associated with the local node or the central node. As described herein, based on a location of the local node, there may be high delay in accessing the data and leading to a decline in the overall performance. Consequently, it may be useful to identify and retrieve data from the tree data structure that is relevant to the local node. Such retrieval may be tailored to the specific management policies that are relevant to the local node and/or the central node. Retrieving a sub-tree based on a management policy removes redundancies, and generates a sub-tree that is relevant to the local node or the central node.

Generally, the management policy is tailored to be contextual. For example, EPGs may have attributes such as end point, access control, label-based tree relations, and so forth. The management policy may be tailored to such attributes. Also, for example, end points may be devices and/or a list of devices (e.g., associated with a user or organization). The end points may also be device type, such as a switch, a laptop, a mobile device, and so forth. The device itself may be associated with a MAC address, or an IP address. Services may also include attributes such as L2, L3, type, port ranges, VLANs, and so forth. In turn, L2 attributes may include various properties of L2 service abstractions. As described herein, each attribute is representative of a context, and the management policy is tailored to such contextual information. Accordingly, a sub-tree that is retrieved based on the management policy is also responsive to contextual information, making it more relevant, and enabling efficient storage, faster search and retrieval, and making it easy to update.

In some examples, the management policy may include at least one of a depth of the sub-tree, a relationship between nodes in the SDN environment, a number of dependent labels in the sub-tree, a number of database calls from the local node to the central node, and a constraint on a computing resource at the local node.

In some examples, the instructions to retrieve the sub-tree of the data structure include further instructions to shard the sub-tree. In some examples, sharding may be based on dependence of an EPG on other EPGs. For example, if G(A)={X, Y, Z}, then the data stored in A will also store attributes of X, Y, and Z. Also, for example, if A is located in a first database associated with a first central node, then the attributes of A are sharded into A's local sub-tree.

The length of the sharded sub-tree may be associated with a threshold length that may be determined to reduce memory allocation and/or decrease processing times. In some examples, the sharded sub-tree may be based on the size of the EPG. Generally, if the length of a tree is large, then it may not be desirable to store all features of the tree. Instead, a determination of an appropriate length may be made based on resource dependencies.

Also, for example, as described, constraints may be based on classifiers. Accordingly, attributes associated to related constraints may be sharded onto the client-side.

In some examples, the sharding algorithm may be determined based on solving an optimization problem, as follows:

Maximize Shard {Parent(A), Children(A), Relation(A)};

Subject to:
Length of sharded sub-tree;
Dependents of A;
Constraints(A).

Accordingly, the factors for generating distributed sharded sub-trees may be based on a depth of a sub-tree, relationship map of nodes with other nodes (where the other nodes are in the same sub-tree or in different sub-trees), depth of dependent labels, a number of database calls from the client or server side, and resource constraints including the memory of the client device, processing time, and so forth. For example, if the depth of a label tree comprising EPGs X, Y, and Z exceeds a design constant, then the size of the sharded sub-tree may be limited.

Memory 104 may store instructions for a system component 110 to cache sub-trees of the data structure at respective local nodes to generate a distributed data structure in the environment. The term “distributed” as used herein generally means that the mapping service database and/or the cached sub-trees may be distributed across applications, end point groups, classifiers, and so forth, and may be maintained independently, in order to enable effective mapping.

In some examples, the instructions executable by the at least one processor may include instructions to identify, in the tree data structure, a second node dependent on the local node, and retrieve, from the central node, a second sub-tree associated with the second node. The instructions may include instructions to append the second sub-tree to the cached sub-tree at the local node.

There are several advantages to creating such a distributed data structure. For example, sharding techniques are focused on significance of a sub-tree in the management policy, and such techniques therefore enhance synchronization across various label trees and across domains. In some examples, the instructions executable by the at least one processor may include instructions to synchronize the sub-tree at the local node and the tree data structure at the central node. Also, for example, a distributed mapping service (DMS) algorithm delivers an overall increase in processing power that may be required to store the entire label-tree in each client server that accesses the LMS service. Generally, a mapping service maps values to keys. A mapping service without context may not be suitable to import and use as a system model. This may be because the system model may have to include more integration to read the format of mapped objects. Accordingly, a DMS may provide context to the mapped objects and profile the content based on usability.

The distributed data structure may be effective in multi-domain networks. For example, when multiple domains have their own LMS, and such LMS has limited interfaces with external entities, and/or the compilation is performed internally, then a distributed data structure effectively extracts relevant portions of the master tree data structure. Multi domain entities may include a first collection of network providers that have an agreement with a second collection of network providers to utilize the overseas connectivity provided by the second collection of network providers. For example, domestic providers of mobile service may contract with foreign mobile service providers to allow respective users to have service across national boundaries. A multi domain network may also include each domain with its unique label names that are shared by another domain. A sharded sub-tree may remove potential conflicts arising from shared label names.

A sharded sub-tree may also enhance network security. For example, clients may be provided access to a sub-tree that may be relevant to their needs, and be restricted from accessing the master tree data structure. This may also enable more efficient detection and/or mediation of potential threats.

In some examples, the network may be a social network, which is generally a graph based network. The LMS for such a network may be distributed via sharded sub-trees to avoid redundant processing of data. Another example of a network may be a content delivery network (CDN), that generally requires processing across various applications. For example, an internet of things (IoT) may include multiple label trees for each client user f the network. In such a situation, a client specific sharded sub-tree may be more relevant. For clients such as mobile phones or Bluetooth enabled devices, a sharded sub-tree may reduce processing time.

In some examples, the instructions may include instructions to receive, at the local node of the network, a data request directed to the tree data structure located at the central node, and respond to the data request based on the cached sub-tree of the data structure. Locally cached sub-trees also reduce a need for search-traversal via large label-trees representative of data in a large organization. As another example, in a complex network of devices, for example, with a plurality of SDN controllers, the cached sub-trees address a need for availability of LMS in proximity to the service, by providing relevant label-tree groups within the required controller.

In some examples, client-side policy management may be an important use-case of LMS. In such situations, the DMS may provide a cached sub-tree of labels. Accordingly, the client service may no longer need to make a remote database call for each policy compilation. This may result in reduced utilization of memory resources. Also, for example, since the sharded component is based on policy dependence, efficient reverse-mapping capabilities may be available.

As described herein, EPGs may be associated with attributes. However, in some examples, an EPG may have specific attributes and access control lists. Also, for example, some attributes may be static, and some attributes may be dynamic. Accordingly, context aware tagging may be performed to associate attributes with EPGs, services, and so forth.

For example, in a networking environment, there may be multiple devices, departments, organizations, use cases, and so forth. The structure for the devices may be a hierarchical key-based map structure in a context-aware manner that would support efficient policy-based sharding. Accordingly, key-value policy labels may be stored to promote key-value based sharding. To render each label unique, labels may be either generated with a unique name or the key may associate the name to a UUID identifier string or a large unique string. This unique string may be associated with static elements of the EPG, for example the UUID of the key “Bob of Company A”, may associate to the MAC IDs of Bob's office devices connected to the network which include the static IPs of his work station or the dynamic IPs of his own devices.

In some examples, a user for an EPG or an application may provide self-named labels. In such examples, each label may be associated with a unique string. In some examples, the label may be provided with a map of key-value pairs, where the key may be either a static-profile such as a MAC address or a dynamic profile such as an IP address or a port number. In some examples, the key may comprise and outer key and an inner key. For example, the outer key may be the label name, and the inner key may be the name of a specific profile based on the desired property, use-case or application.

In some examples, hierarchical relations between different end-point groups may be utilized to manage metadata. Also, for example, sub-keys within each key-value pair may be utilized to shard more efficiently. For example, a client-service that performs monitoring and deployment of security policies across a network may utilize the availability of label names of end-points and services associated to the department for the specific policy for dynamic analysis and management. Such metadata and its relations may be available at the client-service location. The distributed mapping service (DMS) algorithm may shard labels based on the security property and associated access control to be able to successfully deploy the security rules and make it available to the client-service. This may generally enhance the utility and efficiency of policy-based sharding technique such as DMS.

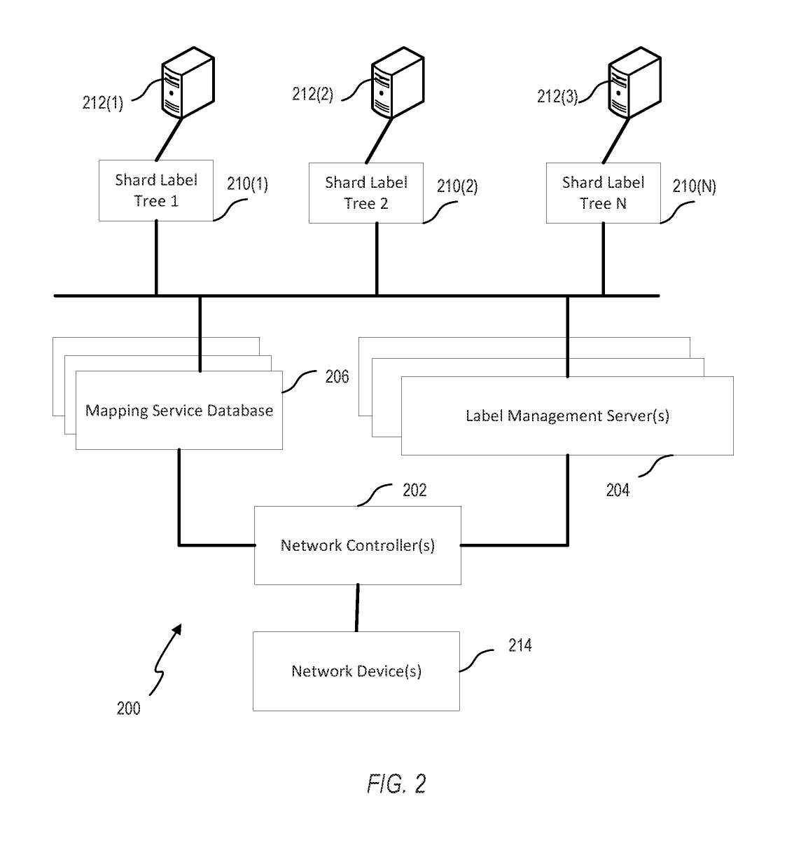

FIG. 2 is a functional block diagram illustrating another example of a system 200 for a distributed data structure in an SDN environment. System 200 described with reference to FIG. 2 may share some aspects of system 100 as described with reference to FIG. 1.

System 200 includes a network controller 202 such as an SDN controller, and label management servers (LMS) 204 capable of associating labels to data items. System 200 also includes a mapping service database 206, such as a database mapping service (DMS) where values are mapped to keys. In some examples, a first label may include a name, an index number, information about what it means, and so forth. System 200 also includes sharded label trees, such as sharded label tree 1 210(1), sharded label tree 2 210(2), . . . , sharded label tree N 210(N). The sharded label trees 210 are communicatively linked to the label management servers 204 and the mapping service database 206. Generally, the sharded label trees 210 may include nodes and data associated with the nodes.

In some examples, the network controllers 202 may be a centralized SDN or local SDNs. A plurality of network controllers 202 may be in sync with each other via a central database. These network controllers 202 may provide information to the sharded label trees 210. Each sharded label tree 210 may be communicatively linked to one or more network controllers 202. The sharded label trees 210 are each connected to local devices (local nodes) 212. The network controllers 202 are communicatively linked to a plurality of network devices 214 that comprise the network.

As described herein, a central SDN controller 202 may have access to a master tree data structure. A local SDN controller, say local node 212(1), may retrieve a sharded sub-tree 210(1) of the data structure. If the data structure is the LMS 204, then the sharded sub-tree 210(1) is a shard label tree 1 210(1). The sub-tree 210(1) may be determined based on a management policy associated with the local node 212(1) or the central node 202. The sub-tree 210(1) may be cached at local node 212(1). The cached sub-trees at each of the local nodes 212 generate a distributed data structure in the environment.

In some examples, a client device in the network, such as a network device 214 may make a data request at a network controller 202. The network controller 202 may access a local node 212(1), which may determine if a condition related to a management policy is satisfied, where the policy may be associated with the local node 212(1). The local node 212(1) may then retrieve data from a tree data structure located at a central node or centralized SDN controller 202, or from a shard label tree 1 210(1). The network controller 202 may then respond to the data request based on the retrieved data.

The components of system 100 or system 200 may be computing resources, each including a suitable combination of a physical computing device, a virtual computing device, a network, software, a cloud infrastructure, a hybrid cloud infrastructure that may include a first cloud infrastructure and a second cloud infrastructure that is different from the first cloud infrastructure, and so forth. The components of the system may be a combination of hardware and programming for performing designated functions. In some instances, each component may include a processor and a memory, while programming code is stored on that memory and executable by a processor to perform a designated function.

Generally, the components of system 100 or system 200 may include programming and/or physical networks to be communicatively linked to other components of each respective system. In some instances, the components of each system may include a processor and a memory, while programming code is stored and on that memory and executable by a processor to perform designated functions.

Generally, the system components may be communicatively linked to computing devices. A computing device, as used herein, may be, for example, a web-based server, a local area network server, a cloud-based server, a notebook computer, a desktop computer, an all-in-one system, a tablet computing device, a mobile phone, an electronic book reader, or any other electronic device suitable for provisioning a computing resource to perform a unified visualization interface. The computing device may include a processor and a computer-readable storage medium.

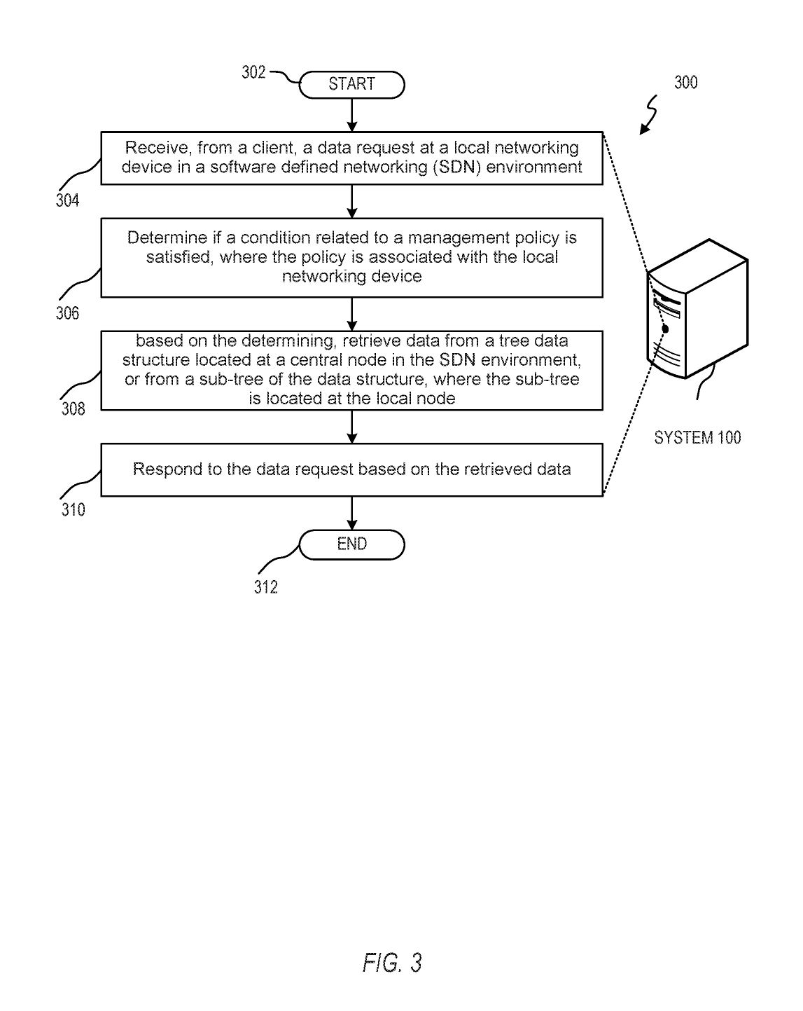

FIG. 3 is a flow diagram illustrating one example of a method for a distributed data structure in an SDN environment. In some examples, such an example method may be implemented by a system such as, for example, system 100 of FIG. 1, and/or system 200 of FIG. 2. The method 300 may begin at block 302, and continue to end at block 312.

At 304, a data request at a local networking device in a software defined networking (SDN) environment may be received from a client.

At 306, it may be determined if a condition related to a management policy is satisfied, where the policy is associated with the local networking device.

At 308, based on the determining, data may be retrieved from a tree data structure located at a central node in the SDN environment, or from a sub-tree of the data structure, where the sub-tree is located at the local node.

At 310, a response to the data request may be provided based on the retrieved data.

As described herein, in some examples, determining if the condition related to the management policy is satisfied may include determining that the data request is a first time data request, and the method may further include retrieving the data from the tree data structure located at the central node.

In some examples, determining if the condition related to the management policy is satisfied may include determining that the data request is not a first time data request, and determining that a number of requests per sub-tree does not exceed a policy requests threshold, and the method may further include retrieving the data from the tree data structure located at the central node.

In some examples, determining if the condition related to the management policy is satisfied may include determining that the data request is not a first time data request, determining that a number of requests per sub-tree exceeds a policy requests threshold, and determining that a depth of the sub-tree exceeds a depth threshold, and a size of the sub-tree exceeds a size threshold, and the method may further include sharding the sub-tree of the data structure, and retrieving the data from the sharded sub-tree.

In some examples, determining if the condition related to the management policy is satisfied may include determining that the data request is not a first time data request, determining that a number of requests per sub-tree exceeds a policy requests threshold, determining that a depth of the sub-tree does not exceed a depth threshold, or a size of the sub-tree does not exceed a size threshold, and determining that the sub-tree has no relational trees, and the method may further include sharding the sub-tree of the data structure, and retrieving the data from the sharded sub-tree.

In some examples, determining if the condition related to the management policy is satisfied may include determining that the data request is not a first time data request, determining that a number of requests per sub-tree exceeds a policy requests threshold, determining that a depth of the sub-tree does not exceed a depth threshold, or a size of the sub-tree does not exceed a size threshold, determining that the sub-tree has relational trees, and determining that the sub-tree relational impact factor exceeds an impact threshold, and the method may further include sharding the sub-tree of the data structure, and retrieving the data from the sharded sub-tree.

In some examples, determining if the condition related to the management policy is satisfied may include determining that the data request is not a first time data request, determining that a number of requests per sub-tree exceeds a policy requests threshold, determining that a depth of the sub-tree does not exceed a depth threshold, or a size of the sub-tree does not exceed a size threshold, determining that the sub-tree has relational trees, and determining that the sub-tree relational impact factor does not exceed an impact threshold, and the method may further include retrieving the data from the tree data structure located at the central node.

In some examples, the method may further include synchronizing the sub-tree at the local networking device and the tree data structure at the central node in the SDN environment.

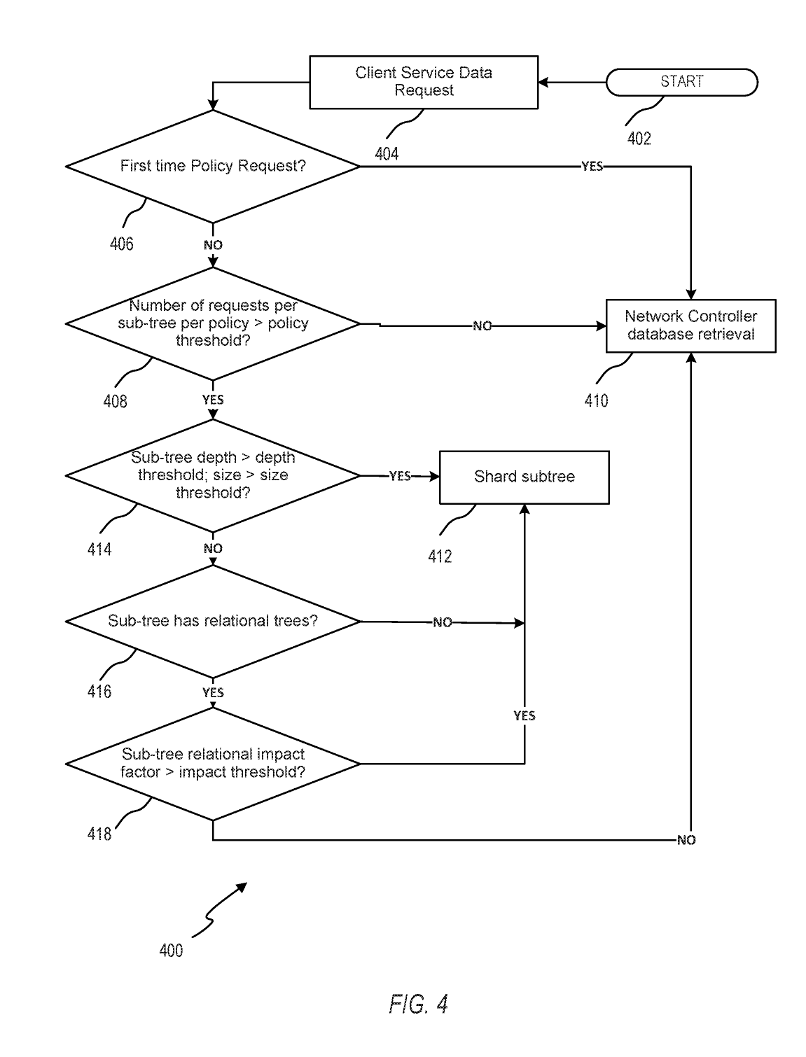

FIG. 4 is another flow diagram illustrating one example of a method for a distributed data structure in an SDN environment. The method 400 may begin at block 402.

At block 404, a client service data request may be received.

At block 406, it may be determined if the request is a first time policy request. If it is a first time policy request, then the method proceeds to block 410 to retrieve the relevant information from a central database (e.g., master tree data structure) that may be stored at a centralized network controller (e.g., a centralized SDN controller).

If at block 406 it is determined that the request is not a first time policy request, then the method may proceed to block 408 to determine if the number of requests per sub-tree per policy exceeds a policy threshold. The term “policy” as used herein, generally refers to a communication link between two nodes on a network indicating whether the two nodes may or may not communicate with each other. Generally, an LMS has a large number of nodes and various relationships between nodes. For example, the sub-tree may include labels for an IT group in a company. Accordingly, the number of requests per sub-tree per policy may refer to a number of IT service requests.

If the number of requests per sub-tree per policy does not exceed the policy threshold, this may be indicative of a small sub-tree. Accordingly, there may be no need to shard the sub-tree, and the method may proceed to block 410 to retrieve the relevant information from a central database (e.g., master tree data structure) that may be stored at a centralized network controller (e.g., a centralized SDN controller).

If the number of requests per sub-tree per policy exceeds the policy threshold, the method may proceed to block 414 to determine if the depth of the sub-tree exceeds a depth threshold, and if the size of the sub-tree exceeds a size threshold. If it is determined that both these conditions are satisfied, the method may proceed to block 412 to shard the sub-tree. Generally, we would want to place limits on the depth and the size of the sharded sub-tree to continue to maintain efficiencies in memory usage, processing times, etc.

If at block 414, it is determined that either the depth of the sub-tree does not exceed the depth threshold, or that the size of the sub-tree does not exceed the size threshold, the method may proceed to block 416 to determine if the sub-tree has any relational trees. For example, in an LMS, a given node may have relationships with other nodes in the label tree. If it is determined that the sub-tree has no relational trees, then the method may proceed to block 412 to shard the sub-tree.

If it is determined that the sub-tree has relational trees, then the method may proceed to block 418 to determine if the sub-tree relational impact exceeds an impact threshold. Generally, if a sub-tree has many relational trees, then a sharded sub-tree may also inherit many relational tress. If the sub-tree relational impact exceeds the impact threshold, then the method may proceed to block 412 to shard the sub-tree. If the sub-tree relational impact does not exceed the impact threshold, then the method may proceed to block 410 to to retrieve the relevant information from a central database (e.g., master tree data structure) that may be stored at a centralized network controller (e.g., a centralized SDN controller).

It may be noted that method 400 is an example flow chart representative of how a management policy may be utilized to generate relevant sharded sub-trees. In particular, the logical dependencies for the modules in method 400 may be permuted in several ways. For example, block 414 may be determined prior to block 408. In some examples, two blocks may be combined into one decision block, or one block may be split into multiple decision blocks. For example, block 414 may comprise two separate blocks, one to compare the depth of the sub-tree with the depth threshold, and another to compare the size of the sub-tree with the size threshold. In some examples, several determinations may be performed independent of one another. For example, determinations at blocks 408, 414, and 416 may be made independent of one another.

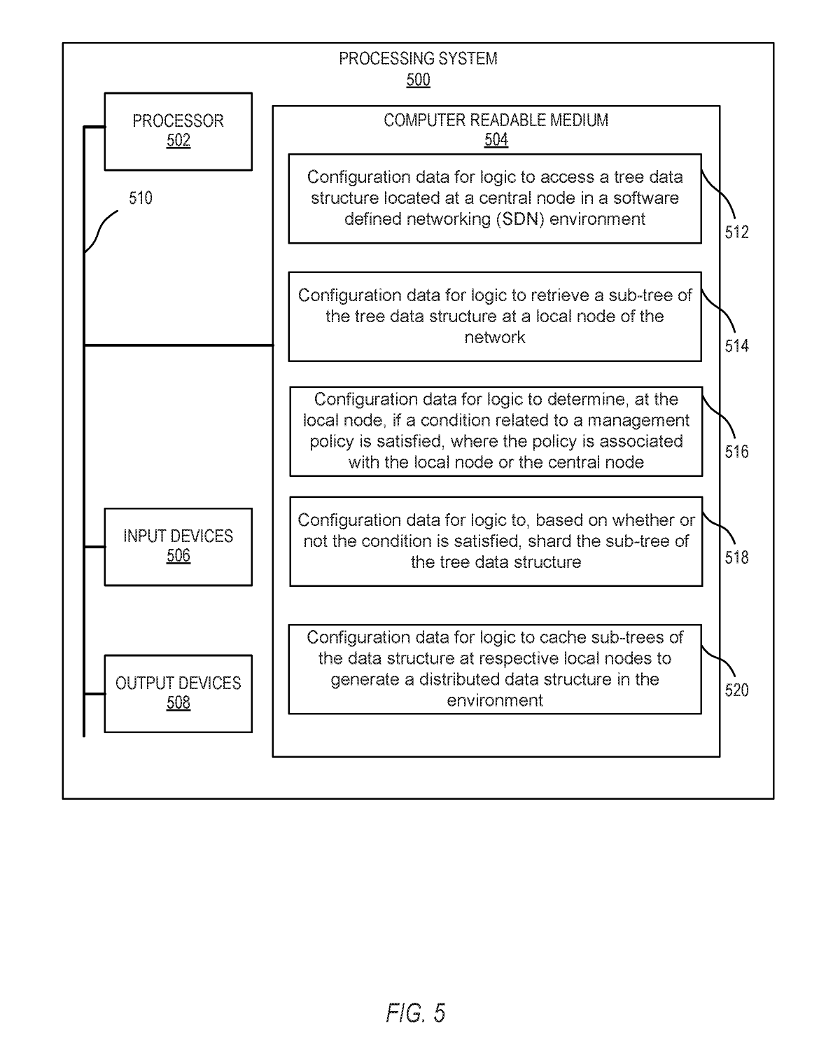

FIG. 5 is a block diagram illustrating one example of a computer readable medium for a distributed data structure in an SDN environment. Processing system 500 includes a processor 502, a computer readable medium 504, input devices 506, and output devices 508. Processor 502, computer readable medium 504, input devices 506, and output devices 508 are coupled to each other through a communication link (e.g., a bus) 510. In some examples, the non-transitory, computer readable medium 504 may store configuration data for the logic to perform the various functions of the processor 502.

Processor 502 executes instructions included in the computer readable medium 504 that stores configuration data for logic to perform the various functions. Computer readable medium 504 stores configuration data for logic 512 to access a tree data structure located at a central node in a software defined networking (SDN) environment.

Computer readable medium 504 stores configuration data for logic 514 to retrieve a sub-tree of the tree data structure at a local node of the network.

Computer readable medium 504 stores configuration data for logic 516 to determine, at the local node, if a condition related to a management policy is satisfied, wherein the policy is associated with the local node or the central node.

Computer readable medium 504 stores configuration data for logic 518 to, based on whether or not the condition is satisfied, shard the sub-tree of the tree data structure.

Computer readable medium 504 stores configuration data for logic 520 to cache sub-trees of the data structure at respective local nodes to generate a distributed data structure in the environment. In some examples, this may facilitate access to the data by a SDN controller at the local node, another node in the SDN environment, or a client such as a device or application.

In some examples, the management policy associated with the local node may include at least one of a depth of the sub-tree, a relationship between nodes in the SDN environment, a number of dependent labels in the sub-tree, a number of database calls from the local node to the central node, and a constraint on a computing resource at the local node.

In some examples, computer readable medium 504 includes instructions to synchronize the sub-tree at the local node and the tree data structure at the central node.

In some examples, computer readable medium 504 includes instructions to identify, in the tree data structure, a second node dependent on the local node, retrieve, from the central node, a second sub-tree associated with the second node, and append the second sub-tree to the cached sub-tree at the local node.

In some examples, computer readable medium 504 includes instructions to receive, at the local node of the network, a data request directed to the tree data structure located at the central node, and respond to the data request based on the cached sub-tree of the data structure.

As used herein, a “computer readable medium” may be any electronic, magnetic, optical, or other physical storage apparatus to contain or store information such as executable instructions, data, and the like. For example, any computer readable storage medium described herein may be any of Random Access Memory (RAM), volatile memory, non-volatile memory, flash memory, a storage drive (e.g., a hard drive), a solid state drive, and the like, or a combination thereof. For example, the computer readable medium 504 can include one of or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage containers.

As described herein, various components of the processing system 500 are identified and refer to a combination of hardware and programming to perform a designated visualization function. As illustrated in FIG. 2, the programming may be processor executable instructions stored on tangible computer readable medium 504, and the hardware may include Processor 502 for executing those instructions. Thus, computer readable medium 504 may store program instructions that, when executed by Processor 502, implement the various components of the processing system 500.

Such computer readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

Computer readable medium 504 may be any of a number of memory components capable of storing instructions that can be executed by processor 502. Computer readable medium 504 may be non-transitory in the sense that it does not encompass a transitory signal but instead is made up of memory components to store the relevant instructions. Computer readable medium 504 may be implemented in a single device or distributed across devices. Likewise, processor 502 represents any number of processors capable of executing instructions stored by computer readable medium 504. Processor 502 may be integrated in a single device or distributed across devices. Further, computer readable medium 504 may be fully or partially integrated in the same device as processor 502 (as illustrated), or it may be separate but accessible to that device and processor 502. In some examples, computer readable medium 504 may be a machine-readable storage medium.

Although specific examples have been illustrated and described herein, especially as related to numerical data, the examples illustrate applications to any storage container. Accordingly, there may be a variety of alternate and/or equivalent implementations that may be substituted for the specific examples shown and described without departing from the scope of the present disclosure. This application is intended to cover any adaptations or variations of the specific examples discussed herein.

1. A system, comprising:
at least one processor; and
a memory storing instructions executable by the at least one processor to:
access a tree data structure located at a central node in a software defined networking (SDN) environment;
retrieve, at a local node of the network, a sub-tree of the data structure, the sub-tree determined based on a management policy associated with the local node or the central node; and
cache sub-trees of the data structure at respective local nodes to generate a distributed data structure in the environment.

2. The system of claim 1, wherein the instructions to retrieve the sub-tree of the data structure include further instructions to shard the sub-tree.

3. The system of claim 2, wherein a depth of the sharded sub-tree does not exceed a design threshold.

4. The system of claim 1, wherein the management policy includes at least one of a depth of the sub-tree, a relationship between nodes in the SDN environment, a number of dependent labels in the sub-tree, a number of database calls from the local node to the central node, and a constraint on a computing resource at the local node.

5. The system of claim 1, further comprising instructions to synchronize the sub-tree at the local node and the tree data structure at the central node.

6. The system of claim 1, further comprising instructions to:
identify, in the tree data structure, a second node dependent on the local node;
retrieve, from the central node, a second sub-tree associated with the second node; and
append the second sub-tree to the cached sub-tree at the local node.

7. The system of claim 1, further comprising instructions to:
receive, at the local node of the network, a data request directed to the tree data structure located at the central node; and
respond to the data request based on the cached sub-tree of the data structure.

8. A method, comprising:
receiving, from a client, a data request at a local networking device in a software defined networking (SDN) environment;
determining if a condition related to a management policy is satisfied, wherein the policy is associated with the local networking device;
based on the determining, retrieving data from a tree data structure located at a central node in the SDN environment, or from a sub-tree of the data structure, wherein the sub-tree is located at the local node;
responding to the data request based on the retrieved data.

9. The method of claim 8, wherein determining if the condition related to the management policy is satisfied includes determining if the data request is a first time data request.

10. The method of claim 8, wherein determining if the condition related to the management policy is satisfied includes determining if a number of requests per sub-tree does not exceed a policy requests threshold.

11. The method of claim 8, wherein determining if the condition related to the management policy is satisfied includes determining if a depth of the sub-tree exceeds a depth threshold.

12. The method of claim 8, wherein determining if the condition related to the management policy is satisfied includes determining if a size of the sub-tree exceeds a size threshold.

13. The method of claim 8, wherein determining if the condition related to the management policy is satisfied includes determining if the sub-tree has relational trees.

14. The method of claim 8, wherein determining if the condition related to the management policy is satisfied includes determining if the sub-tree relational impact factor exceeds an impact threshold.

15. The method of claim 8, further comprising synchronizing the sub-tree at the local networking device and the tree data structure at the central node in the SDN environment.

16. A non-transitory computer readable medium comprising executable instructions to:
access a tree data structure located at a central node in a software defined networking (SDN) environment;
retrieve a sub-tree of the tree data structure at a local node of the network;
determine, at the local node, if a condition related to a management policy is satisfied, wherein the policy is associated with the local node or the central node;
based on whether or not the condition is satisfied, shard the sub-tree of the tree data structure; and
cache sub-trees of the data structure at respective local nodes to generate a distributed data structure in the environment.

17. The computer readable medium of claim 16, wherein the management policy includes at least one of a depth of the sub-tree, a relationship between nodes in the SDN environment, a number of dependent labels in the sub-tree, a number of database calls from the local node to the central node, and a constraint on a computing resource at the local node.

18. The computer readable medium of claim 16, further comprising instructions to synchronize the sub-tree at the local node and the tree data structure at the central node.

19. The computer readable medium of claim 16, further comprising instructions to:
identify, in the tree data structure, a second node dependent on the local node;
retrieve, from the central node, a second sub-tree associated with the second node; and
append the second sub-tree to the cached sub-tree at the local node.

20. The computer readable medium of claim 16, further comprising instructions to:
receive, at the local node of the network, a data request directed to the tree data structure located at the central node; and
respond to the data request based on the cached sub-tree of the data structure.
